(19) United States
(12) Patent Application Publication
(10) Pub. No.: US 2008/0172787 A1
(43) Pub. Date: Jul. 24, 2008

(54) AUDIBLE ALERT AND TIMER FOR AN EMERGENCY EYEWASH STATION

(75) Inventors: Deeyu Tao, Attleboro, MA (US); Raymond A. Boissonneault, Upton, MA (US); Michael C. Pereira, Smithfield, RI (US)

Correspondence Address: BARLOW, JOSEPHS & HOLMES, LTD., 101 DYER STREET, 5TH FLOOR, PROVIDENCE, RI, 02903, US

(73) Assignee: SPERIAN EYE & FACE PROTECTION, INC., Smithfield, RI (US)

(21) Appl. No.: 12/015,629

(22) Filed: Jan. 17, 2008

Related U.S. Application Data
(60) Provisional application No. 60/885,661, filed on Jan. 19, 2007.

(51) Int. Cl. A61H 35/02; A47K 17/00; G04F 10/00; G04G 13/00

(52) U.S. Cl. 4/620; 4/638; 368/109; 368/10

(57) ABSTRACT

A timer and alert module for an emergency eyewash station is disclosed. The module includes a housing; a control circuit having a timing cycle contained within the housing; a speaker electrically connected to the control circuit; a switch configured and arranged to disable the control circuit; and a sensor configured and arranged to trigger the control circuit to start the timing cycle. The control circuit selectively activates the speaker periodically during the timing cycle.

### CROSS-REFERENCE TO RELATED APPLICATION

The present patent document claims priority to earlier filed U.S. Provisional Patent Application Ser. No. 60/885,661, filed Jan. 19, 2007, the entire contents of which are incorporated by reference herein.

### BACKGROUND OF THE INVENTION

1. Field of the Invention

The present invention relates generally to emergency eyewash stations and more particularly to an emergency eyewash station has a timer with a speaker.

2. Background of the Related Art

Government and employers are increasingly aware of the need for protecting the health and safety of workers. For this reason, it is common to find eye wash fountains at industrial work sites, laboratories, and other locations where workers are exposed to gaseous fumes, liquids or solid materials which can irritate or injure eyes upon contact therewith. The Occupational Safety and Health Administration (OSHA) has made eye wash fountains mandatory for particular industrial work stations.

Early installations of eye wash fountains employed sprays of regular tap water fed from regular plant plumbing connections. These devices were adequate for a period of time, but suffered from the drawbacks of using the regular water supply. For example, there could be contaminants and bacteria in regular plumbed water. Furthermore, the pressure of regular running water is inconsistent creating an uneven water flow, or in the event of a major facility accident, the water may not be running at all.

Later devices, such as the eye wash fountains disclosed in U.S. Pat. No. 4,012,798 to Liautaud and U.S. Pat. No. 4,363,146 to Liautaud, were self-contained, gravity-fed, and independent of any plumbing connections. These self-contained eye wash fountains typically included a reservoir (or bottles) of wash fluid spaced above two opposed liquid spray nozzles. Upon activating the fluid flow, the wash fluid from the reservoir is fed solely by gravity to the nozzles to cause a gravity-induced spray of wash fluid from the nozzles. These stations provided improved safety in terms of the quality of the water utilized but suffered from low and/or inconsistent water pressure to properly flush the eyes.

In an effort to encourage more suitable eye wash facilities, the American National Standards Institute (ANSI) promulgated voluntary standards for portable eye wash fountains relating to flushing periods and the rate of flow of wash fluid. These standards dictate that portable eye wash fountains should deliver no less than 0.4 gallons per minute (1.5 liters per minute) of eye wash fluid for a time period of 15 minutes. Responsive to the new ANSI standard, several designs emerged that included means for maintaining a constant eye wash flow rate without any powered pumping mechanisms. For example, U.S. Pat. No. 5,566,406, U.S. Pat. No. 5,695,124 and U.S. Pat. No. 5,850,641 all issued to Demeny et al, disclose an emergency eyewash station having a gravity assist mechanism that acts on a flexible reservoir contained in a disposable paperboard box. The self-contained emergency eye wash station generally comprises a housing, a reservoir, and a platen. The housing includes a shelf that supports a pair of flexible containers arranged in side-by-side relation. The flexible containers are of the type generally referred to as “bag-in-a-box” packaging, having an inner flexible plastic bag containing the eyewash fluid, and an outer cardboard box structure, which supports the flexible bag in a predetermined shape. The housing further supports a delivery platform including a nozzle, which is in fluid communication with the flexible container. The nozzle selectively dispenses the eye wash fluid from the flexible container when activated. The housing further includes a drain that captures the eye wash fluid dispensed from the nozzle and directs the eye wash fluid into the reservoir. The reservoir is slidably mounted to the housing and the platen is connected to the reservoir. As the reservoir fills, the platen presses downward on the flexible container with a downward force proportional to a weight of the eye wash fluid collected in the reservoir. The transfer of the weight of the eye wash fluid collected in the reservoir to the platen maintains a constant flow of eye wash fluid dispensed from the nozzle.

The above-noted gravity assist configuration has been very successful in the marketplace and is still in widespread use today. Because the 6 gallons of fluid is divided into two smaller containers, the flexible reservoirs are relatively small and easily replaced by service personnel. In addition, the bag-in-a-box packaging technology is well established, and the costs for producing, maintaining and replacing the disposable cartridges at established intervals of time have heretofore been relatively inexpensive. The costs for this type of system are such that the manufacturer could cost effectively provide a pre-assembled delivery tube and nozzle assembly with each of the disposable cartridges, making installation and replacement that much easier.

However, new ANSI and OSHA regulations have created new issues that will need to be addressed, and will require improvements to the existing designs to maintain compliance. In particular, upcoming OSHA regulations will soon require the use of “sterile” eye wash fluids. The regulatory and production requirements for “sterile” eyewash fluids are far greater than the previous “non-sterile” standards and will make the production of the existing cartridges cost prohibitive. Moreover, OSHA and ANSI recommended guidelines instruct that a user should wash his or her eyes for a full fifteen minutes prior to seeking immediate medical attention.

Accordingly, there is a need in the industry for an improved cartridge assembly which can be filled with a sterile fluid, maintained in a sterile condition for the required shelf-life of the product, provide for safe shipment, handling and storage of the product, and provide for simple installation and replacement, and finally provide a reliable dispensing arrangement for emergency use. In addition, there is a need for a timing system and alert system to inform a user that they have treated their eyes according to OSHA and ANSI standards. Furthermore, there is a need for an improved delivery system which can accommodate the different requirements of the new “sterile” cartridge assemblies, while reducing costs and maintaining simple installation and upkeep of the system.

### SUMMARY OF THE INVENTION

The present invention solves the problems of the prior art by providing an alarm system for emergency eyewash station that signals an audible alert to the area that the eyewash station has been activated. The eyewash station of the present invention also subsequently times and informs the user when they have washed their eyes for a sufficient amount of time as recommended under OSHA and ANSI guidelines so that the individual seeks appropriate medical attention thereafter.

### BRIEF DESCRIPTION OF THE DRAWINGS

These and other features, aspects, and advantages of the present invention will become better understood with reference to the following description, appended claims, and accompanying drawings where:

FIG. 1 is a front perspective view of an emergency eyewash station with the actuator arm closed;

FIG. 2 is a front perspective view of the emergency eyewash station with the actuator arm open;

FIG. 3 is a perspective view of the alarm module of the present invention;

FIG. 4 is a partial cross-section view of an emergency eyewash station showing the alarm module installed;

FIG. 5 is a top perspective view of the alarm module disassembled;

FIG. 6A is a top portion of a flow diagram showing the logic of the timing circuit of the alarm module; and

FIG. 6B is a bottom portion of the flow diagram shown in FIG. 6A.

### DESCRIPTION OF THE PREFERRED EMBODIMENT

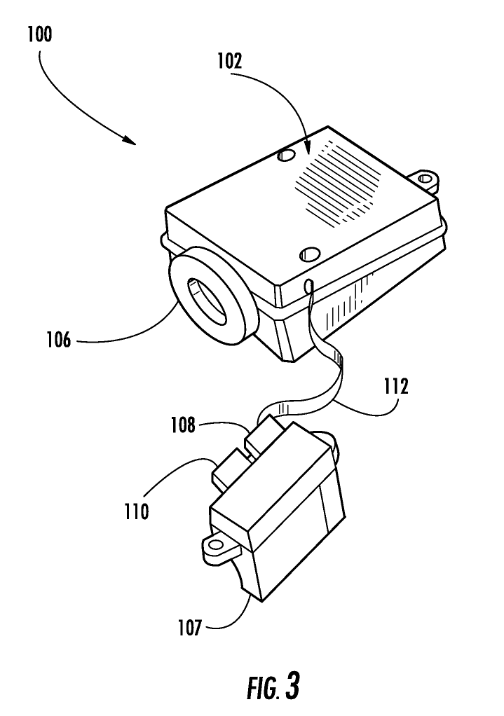

Referring now to FIG. 3, the audible alert and timer module of the present invention is shown generally at 100. The module 100 includes a housing 102; a control circuit 104 having a timing cycle contained within the housing 102; a speaker 106 electrically connected to the control circuit 104; a switch 108 configured and arranged to disable the control circuit 104; and a sensor 110 configured and arranged to trigger the control circuit 104 to start the timing cycle. The control circuit 104 selectively activates the speaker 106 periodically during the timing cycle.

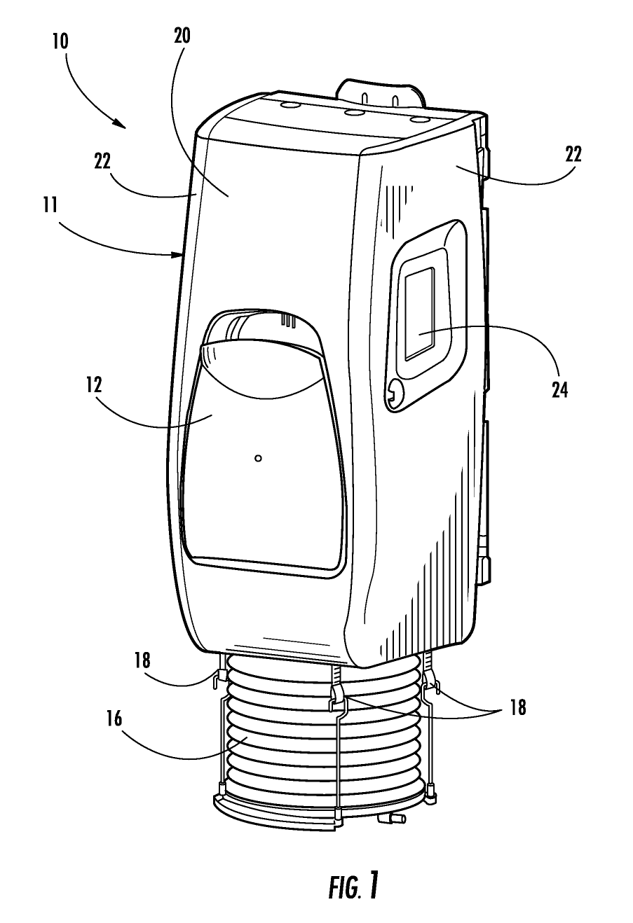

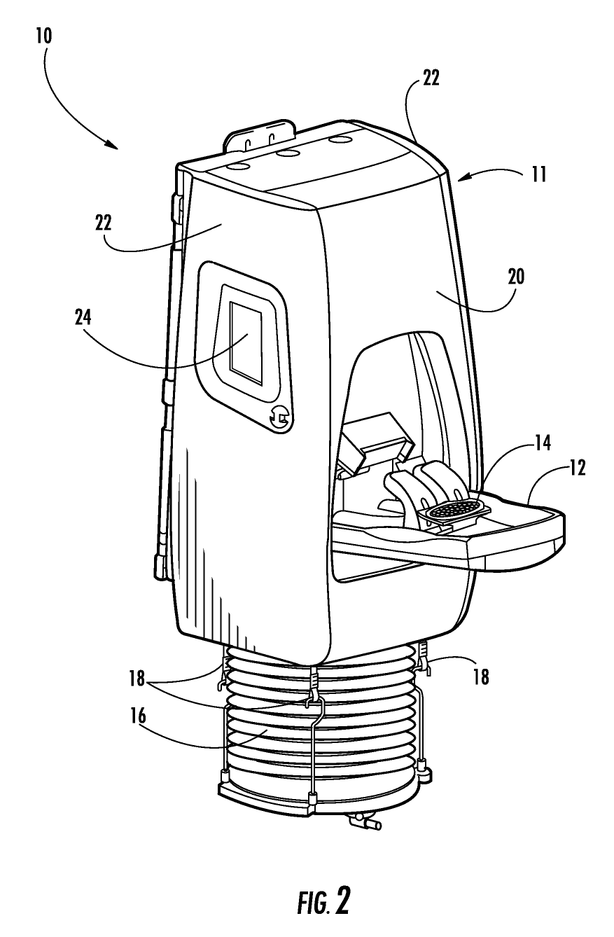

Referring to FIGS. 1 and 2, an emergency eyewash station 10 may include a body 11 having a pivoting actuator arm assembly 12 having a dispensing eyepiece 14 in a fixed position thereon. The actuator arm assembly 12 can be pivoted from an upright closed position to an activated prone position. When in the closed position, the actuator arm assembly 12 conforms to the main body portion 11 to present a uniform appearance and prevent accidental discharge of the eyewash station 10. Although it is preferred that the actuator arm assembly 12 pivot downwardly, one-skilled in the art would appreciate that the actuator arm assembly 12 could be configured and arranged to slide or pivot in another direction as desired with equally effective results. Also included in the eyewash station 10 is a waste collection reservoir system that includes an expandable bellows 16 with straps 18 to assist the gravity feed of the eyewash fluid.

The emergency eyewash station 10 may hung against a wall using a mounting bracket (not shown). The mounting bracket is secured to the wall at an optimum height to allow a user of average height to comfortably operate the emergency eyewash station 10. The body portion 11 includes of a front panel 20 and two interlocking side panels 22. Each of the side panels 22 has an inspection window 24, which permits the user to inspect the interior of the eyewash station 10.

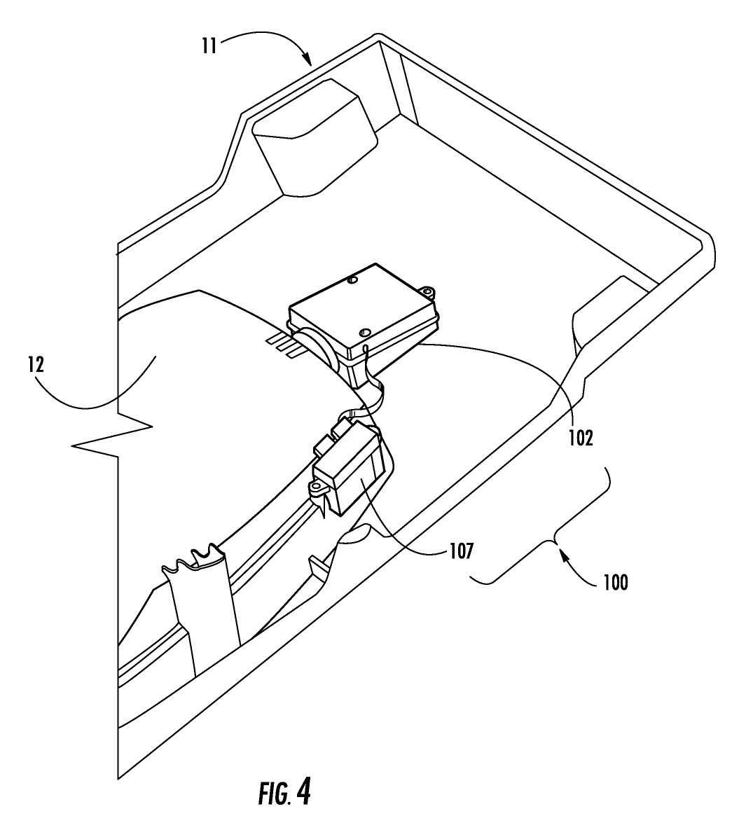

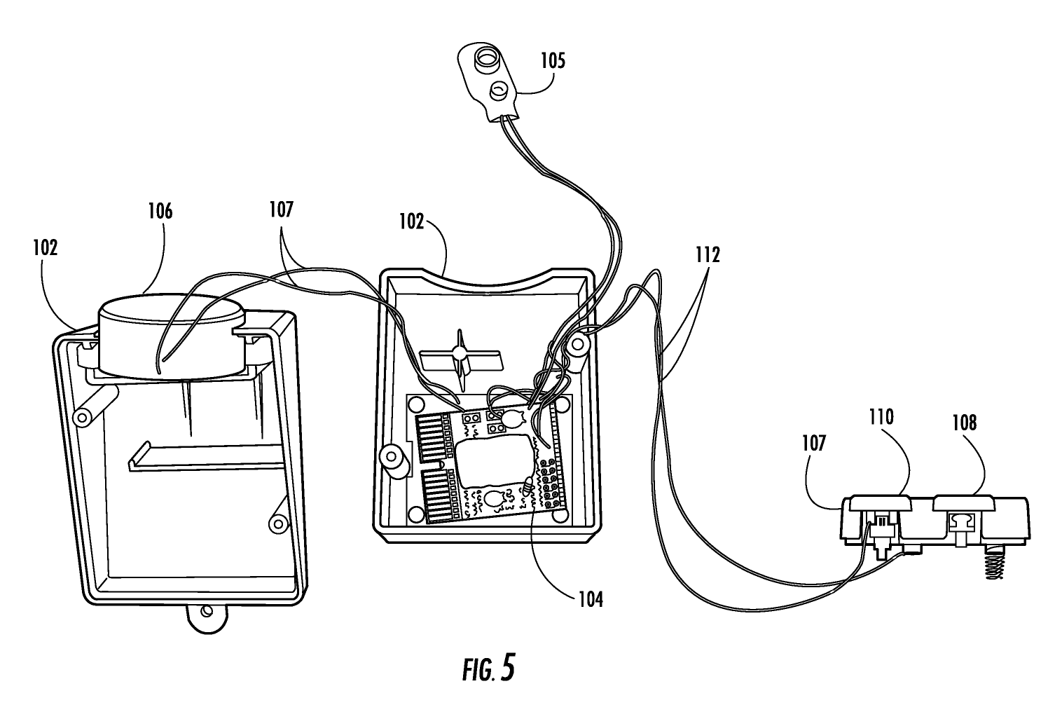

Referring to FIGS. 4 and 5, inside the body portion 11 of the eyewash station 10 is an alarm module 100. The alarm module 100 has a removable housing 102 cover to allow the battery (not shown) to be replaced every two years or after each use of the emergency eyewash station 10, whichever occurs first. The alarm module 100 has a speaker 106 and a control circuit 104, which are powered by the battery. A standard battery connector 105 is provided to enable a battery to be easily connected to the control circuit 104. The speaker 106 is electrically connected to the control circuit 104 via wires 107. The control circuit 104 is connected to and operates the speaker 106. Connected to the alarm module 100 is a switch module 107. The switch module 107 has a trigger switch 110 to activate the control circuit 104 and start a timing sequence and also has a disarm switch 108 to disable the control circuit 104 and the alarm via wires 112.

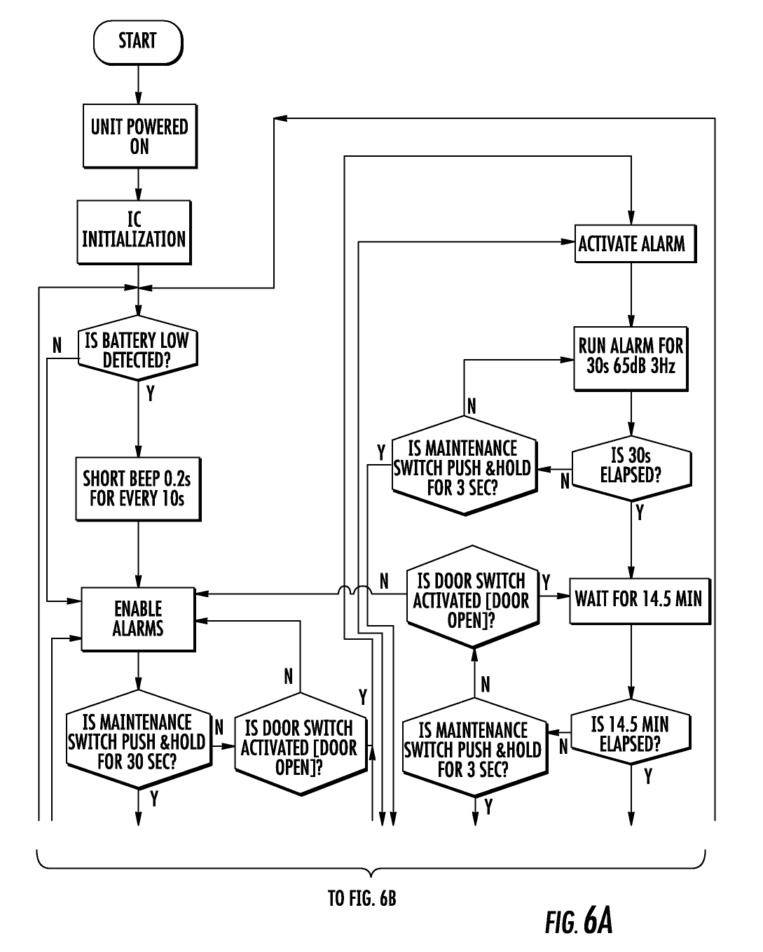

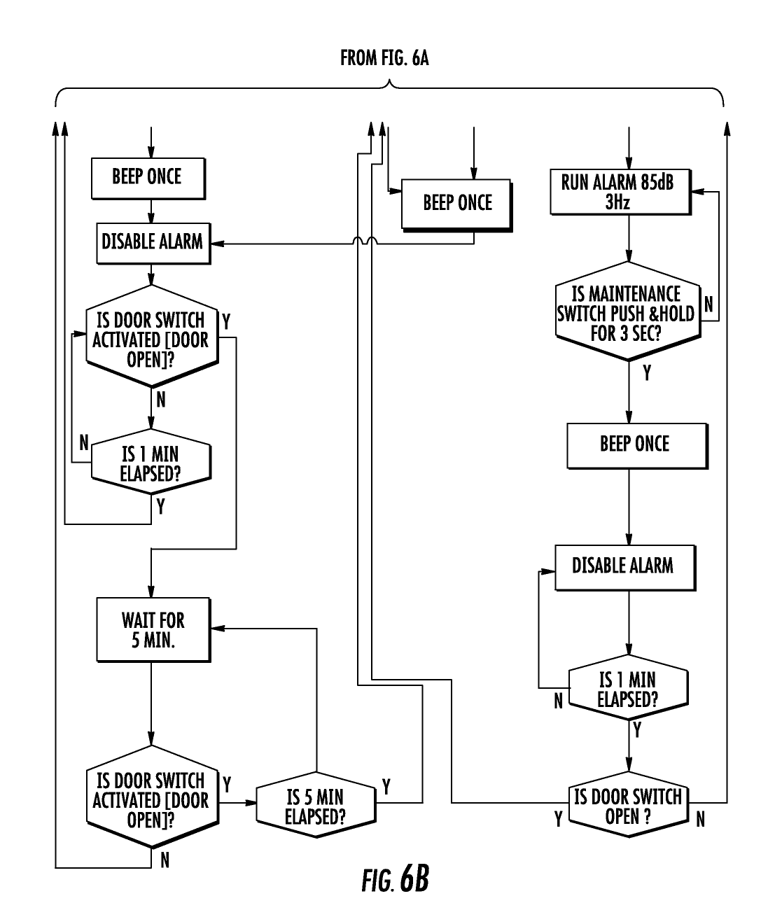

The logic of the control circuit 104 is shown generally in FIGS. 6A and 6B.

To disarm the alarm module 100, the user presses and holds the disarm switch 110 for approximately 3 seconds until a beep is heard that indicates that the control circuit 104 has been disabled. The actuator arm assembly 12 may then be opened on the emergency eyewash station 10 so that the eyepiece 14 may be inspected or the eyewash fluid changed. To rearm the alarm module 100, the user simply closes the actuator arm assembly 12, which depresses the trigger switch 110 and reactivates the control circuit 104.

The control circuit 104 is programmed to sound a short beep through the speaker 106 every 10 seconds to indicate if the battery is low.

When armed, and in addition to commencing the flow of eyewash fluid, pulling the actuator arm assembly 12 to the activated position activates the control circuit 104, which sounds an alarm tone or pulse through the speaker 106 and starts a timing cycle.

Upon initial the activation, the control circuit 104 sounds the alarm tone through the speaker 106 for 30 seconds to alert the general area that the emergency eyewash station 10 has been activated. The alarm tone is loud enough to alert people within the vicinity of the eyewash station 10 that it has been activated.

The user washes their eyes in the fluid flow from the nozzles of the eyepiece 14 immediately upon pulling the actuator arm assembly 12 to the activated position. The control circuit 104 sounds a second alarm tone at the end of the timing cycle, which is 15 minutes, to inform the user that immediate medical assistant should now be sought. The 15 minute wash cycle is indicated by OSHA and ANSI recommended guidelines. Because the user of the eyewash station 10 is impaired, the alarm and timing cycle serve to help the user keep track of how long the user must wash their eyes prior to seeking medical attention according to OSHA and ANSI recommended guidelines.

The timing cycle may also be programmed to sound a tone periodically, for example, every minute or thirty seconds, to keep the user informed of the duration for which they have been washing their eyes. In addition, to tones or beeps, the audible alert of the present invention can also use preprogrammed speech too. For instance, the audible alert can be programmed to sound “one minute remaining” and “seek medical attention now,” among other useful instructions.

Therefore, it can be seen that the present invention provides a unique solution to the problem of providing an emergency eyewash station that not only complies with new OSHA sterile eyewash guidelines and ANSI recommended eyewash flow rates and washing times, but also has an audible alert to warn persons nearby that the emergency eyewash station has been activated and inform the user that they have flushed their eyes for a sufficient period of time.

It would be appreciated by those skilled in the art that various changes and modifications can be made to the illustrated embodiments without departing from the spirit of the present invention. All such modifications and changes are intended to be within the scope of the present invention.

What is claimed is:

1. A timer and alert module for an emergency eyewash station, said module comprising:
a housing;
a control circuit contained within said housing, the control circuit having a timing cycle;
a speaker electrically connected to the control circuit;
a switch configured and arranged to disable the control circuit; and
a sensor configured and arranged to trigger the control circuit to start the timing cycle;
whereby the control circuit selectively activates the speaker periodically during the timing cycle.

2. The module of claim 1, further comprising:
a battery electrically connected to said control circuit.

3. The module of claim 1, further comprising:
a switch housing; and
said switch and said sensor operatively captured by said switch housing.

4. The module of claim 1, wherein said sensor is a second switch.

5. The module of claim 1, wherein said timing cycle is about fifteen minutes long.

6. The module of claim 1, wherein said control circuit activates said speaker for 30 seconds at a beginning and an end of said timing cycle.

7. The module of claim 1, wherein said speaker emits a first noise to alert a user that the timing cycle has commenced and a second noise to alert the user that the timing cycle has completed.

8. The module of claim 1, wherein said speaker is configured and arranged to play a prerecorded message.

9. An emergency eyewash station, comprising:
a body portion;
a reservoir disposed within said body portion, the reservoir containing eyewash fluid therein;
a dispensing structure in fluid communication with the reservoir; and
an actuator assembly coupled to the body portion, the actuator assembly being movable between an armed position and an actuated position,
a control circuit contained within the body portion, the control circuit having a timing cycle;
a speaker electrically connected to the control circuit;
a switch configured and arranged to disable the control circuit; and
a sensor configured and arranged to trigger the control circuit to start the timing cycle when the actuator assembly is moved from the armed position to the actuated position;
said eyewash fluid being dispensed from the reservoir to the dispensing structure when the actuator assembly is moved from the armed position to the actuated position;
whereby the control circuit selectively activates the speaker periodically during the timing cycle.

10. The eyewash station of claim 9, further comprising:
a control circuit housing coupled to said body portion, the control circuit housing enclosing said control circuit and said audible alert.

11. The eyewash station of claim 9, further comprising:
a battery electrically connected to said control circuit.

12. The eyewash station of claim 9, further comprising:
a switch housing coupled to said body portion; and
said switch and said sensor operatively captured by said switch housing.

13. The eyewash station of claim 9, wherein said sensor is a second switch.

14. The eyewash station of claim 9, wherein said timing cycle is about fifteen minutes long.

15. The eyewash station of claim 9, wherein said control circuit activates said speaker for 30 seconds at a beginning and an end of said timing cycle.

16. The eyewash station of claim 9, wherein said speaker emits a first noise to alert a user that the timing cycle has commenced and a second noise to alert the user that the timing cycle has completed.

17. The eyewash station of claim 9, wherein said speaker is configured and arranged to play a prerecorded message.
